(19) United States
(12) Patent Application Publication
(10) Pub. No.: US 2024/0308144 A1
(43) Pub. Date: Sep. 19, 2024

(54) IDENTIFYING IRREGULARITIES IN ADDITIVELY MANUFACTURED OBJECTS TO EVALUATE STRUCTURAL INTEGRITY AND QUALITY

(71) Applicant: KAIROS, Inc., Cailifornia, MD (US)

(72) Inventor: David Louis Edelen, III, Charlotte Hall, MD (US)

(21) Appl. No.: 18/672,368

(22) Filed: May 23, 2024

Related U.S. Application Data
(63) Continuation-in-part of application No. 17/204,755, filed on Mar. 17, 2021, now Pat. No. 12,023,869.
(60) Provisional application No. 62/990,508, filed on Mar. 17, 2020.

(51) Int. Cl. B29C 64/393; B29C 64/20; B33Y 30/00; B33Y 50/02

(52) U.S. Cl. CPC B29C 64/393; B29C 64/20; B33Y 30/00; B33Y 50/02

(57) ABSTRACT

A system for detecting irregularities in three-dimensional parts being manufactured using an additive manufacturing process. Data arrays (e.g., images) of the manufactured cross section are obtained via a sensor (e.g., camera, LiDAR sensor, laser measuring sensor, ultrasonic sensor), then processed for irregularities as the object manufacturing cycle progresses. This data is processed through computational algorithms in order to identify areas of compromised integrity or quality. This data is then used to determine the risk of the part as manufactured, and an assessment is performed to determine if the process should continue. Should the manufacturing process be determined to proceed, the data is stored to be further assessed later by technicians, operators, and/or engineers. Additionally, the data can be utilized to perform a structural analysis to determine if the part is sufficient with the flaws present.

### PRIORITY

This application is a continuation in part (CIP) of, and claims the benefit under 35 U.S.C. § 120, application Ser. No. 17/204,755, filed on Mar. 17, 2021, entitled “Detecting Irregularities In Layers Of 3-D Printed Objects And Assessing Integrity And Quality Of Object To Manage Risk”, and having David Louis Edelen III as inventor. application Ser. No. 17/204,755 claims the priority under 35 U.S.C. § 119 of Provisional Application Ser. No. 62/990,508, filed on Mar. 17, 2020, entitled “Apparatus and Method for Assessing Layers in Additively Manufactured Parts for Structural Integrity”, and having David Louis Edelen III as inventor. application Ser. Nos. 17/204,755 and 62/990,508 are incorporated herein by reference in their entirety.

### FIELD OF INVENTION

The present invention relates to the field of additive manufacturing, commonly referred to as 3-D printing. More specifically, an apparatus and data processing method to detect irregularities in the layers of an object being 3-D printed and analyze the detected irregularities for safety, integrity (e.g., structural) and/or quality to appropriately manage risk.

### BACKGROUND

The additive manufacturing process, widely referred to as 3-D printing, is being called the fourth industrial revolution. Within the realm of additive manufacturing, the American Society of Testing and Materials (ASTM) identifies seven main processes which include material jetting, binder jetting, powder bed fusion, vat polymerization, sheet lamination, material extrusion, and direct energy deposition. Material extrusion based 3-D printing has been one of the most widely adopted technologies and is often called Fused Filament Fabrication (FFF). FFF 3-D printing utilizes thermoplastic materials that are precisely extruded to manufacture a part. This technology was originally intended for manufacturing fast and cheap prototype parts that could be used to confirm fit and function before manufacturing that part via other processes that require significant cost. However, with advancements in material science and the growing understanding of the manufacturing process, FFF 3-D printing is being adapted to manufacture functional, end-use parts that require structural integrity.

At first, thermoplastics such as Polylactic Acid (PLA) or Acrylonitrile Butadiene Styrene (ABS) were most commonly used due to their low cost and relative ease of use. However, the underwhelming characteristics of these materials, such as strength and chemical resistance, limit their practicality for use in more demanding applications. Now, higher performance, more advanced materials such as Polyether Ether Ketone (PEEK), Polyether Ketone Ketone (PEKK), Polyphenylsulphone (PPSU), and Polyetherimide (PEI) that have aerospace and/or medical certifications are being utilized in FFF 3-D printing systems. The advanced materials may be mixed with filler such as glass fiber, carbon fiber, lubricants, and other additives for highly tailored applications. These more advanced materials enable users to manufacture functional parts, or parts that need structural integrity, on demand, with minimal waste or tooling cost. This shift significantly increases the market potential for use applications of the manufacturing process and could be very disruptive to traditional supply chain processes.

The typical FFF 3-D printing technique consists of feeding a thermoplastic filament through a heated extruder to deposit a controlled volume of material along a specified path. The extrusions are deposited onto the heated build platform initially, and then onto itself as subsequent layers of the part are manufactured.

While FFF additive manufacturing with thermoplastics is one of the most popular and widely used 3-D printing methods, the material extrusion method can be configured for other highly useful applications. Metal additive manufacturing is becoming increasingly feasible for production. Additional areas of interest include the extrusion of concrete in the 3-D printing of homes, biological cells in the 3-D printing of organs, and energetic materials in the 3-D printing of solid propellants or the like.

In many traditional manufacturing or additive manufacturing applications, parts are evaluated for quality after being manufactured. This could be dimensional checks with hand measuring devices, destructive testing, or non-destructive testing like an x-ray. This methodology is flawed because the part is already fully manufactured before assessment, so upon rejection, all the material is wasted.

FIG. 1 illustrates an example flow diagram 100 of a typical material extrusion 3-D printer manufacturing an object (e.g., part). The 3-D object to be created is processed through a computer program, commonly known as a slicer, which creates the toolpath instruction for the printer to follow. The toolpath instructions are included in a g-code file that contains all the coordinates of the 3-D part and tells the printer basic settings such as extruder temperatures and delineates the extrusion paths. The g-code file is uploaded into the 3-D printer system 110 and the 3-D printer begins extruding the desired material along the predetermined path to create a cross sectional area of the object (extrudes the object layer by layer) 120. Once a layer has been manufactured, the 3-D printer determines if the object is complete (last layer was extruded) 130. If the object is complete (130 Yes), the 3-D printer is stopped, and the object is removed 140. If the object is not complete (130 No), additional layers need to be printed for the object and the process continues for the next layer 120.

During this manufacturing cycle, the process is assumed to be ideal or perfect, and no monitoring is performed. This is commonly referred to as an open-loop control system. In reality, the manufacturing process is highly complex, making it susceptible to errors and variations, which can highly influence the resulting performance of the part, compromising the structural integrity or quality, and potentially creating a safety hazard.

Additive manufacturing significantly increases the design freedom, allowing complex geometries to be made that could not be manufactured with any previously known methods. With this substantial increase in design freedom, there is also a much greater potential for manufacturing errors. These structural irregularities are the result of unintentional deviations from the planned process or procedure and are typically not accounted for in the anticipated design. For example, in the FFF 3-D printing process, these irregularities can be attributed to commonly known problems such as nonconformities in the extruder flowrate (potentially due to nozzle clogs, unplanned filament diameter changes, incorrect extrusion multipliers, or incorrect extrusion widths), nonconformities in extruder positioning such as inaccurate layer height positioning, deviations in extruder temperature, deviations in the build platform temperature, premature cooling of the previously manufactured layer, or inadequate layer bonding. These irregularities could also be present in other extrudable materials such as air bubbles in 3-D printed concrete or the like.

For successful adoption of the FFF 3-D printing process for functional parts that require structural integrity, the manufacturing cycle requires strict monitoring and control to ensure consistency, quality, and safety. In the case of a part being used in an aerospace application, a part failure contributed to a structural irregularity could result in significant loss in money, injury, and/or death. This potentially catastrophic result warrants the development of a technology to monitor the manufacturing process, detect irregularities, and assess the risk of the potential flaw. The structural integrity is also vital in the 3-D printing of homes with concrete. Irregularities in the extrusion could produce cracks or other unwanted structural attributes, which as a result could cause a house to fail to comply to building codes, especially in areas with seismic activity.

What is needed is the ability to evaluate the integrity of the part as it is being manufactured through non-destructive means.

### SUMMARY

The disclosed embodiments are directed to a system for detecting irregularities in material extrusion 3-D printed parts, and assessing the risk associated with the presence of that irregularity. Data arrays of the recently manufactured cross section may be captured via data array capturing sensors. Sensors are a receptor array that converts physical attributes or phenomena to electrical signals. Sensors that can be utilized to capture data arrays include, but are not limited to, camera(s), laser(s), LiDAR sensor(s), ultrasonic sensor(s), and eddy current sensor(s). The data arrays captured are then processed to detect irregularities before the object manufacturing cycle continues. The data arrays are processed through computational algorithms, utilizing data processing, computer vision, machine learning and artificial intelligence methods in order to accurately identify areas where the manufacturing process has been compromised. This data is then used to determine the risk of the part as manufactured, and an assessment is performed to determine if the process should continue. Should the manufacturing process be determined to proceed, the data is stored to be further assessed later by technicians, operators, scientist, and/or engineers. This data can be used to check against digital twins or structural analysis, such as Finite Element Analysis (FEA), to determine if there are structural irregularities present in areas of critical stress, ultimately determining if the part is safe for the intended application or are otherwise problematic for the application.

In an aerospace or energetics applications, this could be used as a pass/fail quality assurance measure. In the case of a 3-D printed house, a repair procedure can be put in place to mitigate the risk of a structural irregularity without having to destroy the entirety of the building, such as injecting epoxy or the like. Additionally, this information, regardless of the material or application, could be stored and broadcasted to an Augmented Reality/Virtual Reality (AR/VR) headset to give an operator an optical overlay of the flaws and their locations.

By initializing a monitoring system with the capability of distinguishing irregularities, an accurate assessment of the risk can be evaluated, ultimately determining if a threshold has been reached, deeming the part unsafe, and terminating the manufacturing progress to minimize waste and increase safety. This system performs the assessment after a new layer has been manufactured on the 3-D object. If an irregularity is found, the system will use additional computational analysis to determine the size, location, and frequency of the irregularity for further evaluation. This data can be used to determine the effect of present irregularities relative to its idealized service life.

### BRIEF DESCRIPTION OF THE DRAWINGS

The features and advantages of the various embodiments will become apparent from the following detailed description in which:

FIG. 1 illustrates an example flow diagram of a traditional material extrusion 3-D printer manufacturing a part.

FIG. 2 illustrates an example flow diagram of a material extrusion 3-D printer detecting irregularities during the manufacture of a part, according to one embodiment.

FIG. 3 illustrates an example flow diagram of the processing of the g-code file for the object to create mask images for each layer of the object, according to one embodiment.

FIGS. 4A-B illustrate images of example physical details of a layer to be extruded and a corresponding mask layer created therefrom, according to one embodiment.

FIGS. 5A-B illustrate images of example physical details of a layer to be extruded and a corresponding mask layer created therefrom, according to one embodiment.

FIG. 6 illustrates an example flow diagram for utilizing data arrays of the layer extruded to detect irregularities, according to one embodiment.

FIGS. 7A-7H illustrate images of an example layer being captured and processed to identify irregularities, according to one embodiment.

FIGS. 8A-B illustrate an example captured image of an object and the captured image after a mask for most recent layer has been applied, according to one embodiment.

FIGS. 9A-F illustrate the use of mask layers created from the g-code file to remove unwanted portions of the data array captured, according to one embodiment.

FIG. 10A-C illustrate block diagrams of example 3-D printers having an apparatus to obtain the layer data to be processed by the system to determine structural integrity, according to various embodiments.

FIG. 11A-B illustrate example field of view captured for different data array capturing sensors, according to various embodiments.

FIG. 12A-B illustrate an example part with detected irregularities in different areas to show impact of critical area, according to one embodiment.

FIG. 13A-C illustrate a plot of total rated services life versus safety factor of a part based on its unique loading conditions, and the impart thereon of detected irregularities, according to various embodiments.

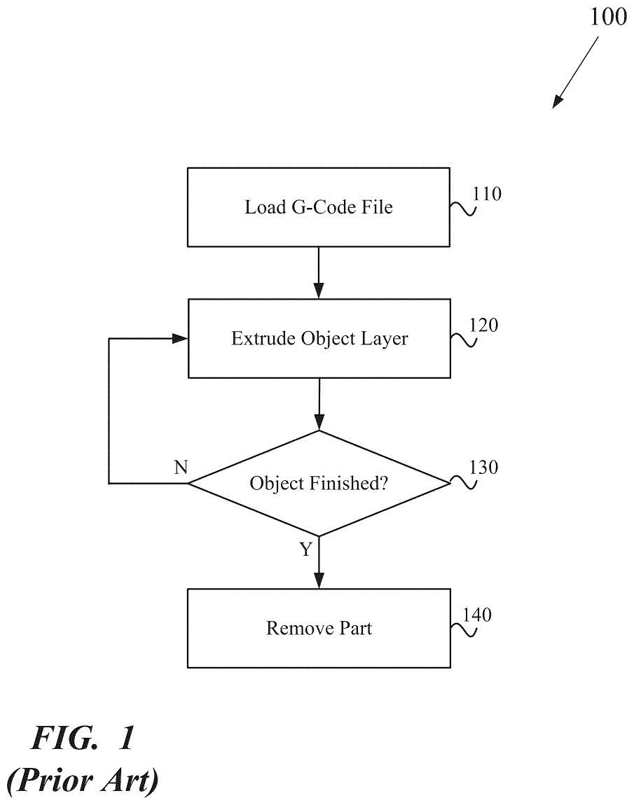

### DETAILED DESCRIPTION OF THE EMBODIMENTS

The disclosed embodiments are directed to an apparatus and method for detecting and assessing irregularities in 3-D printed objects for integrity (e.g., structural) and/or quality to appropriately manage risk. More specifically, a data array capturing and processing system to determine if a freshly manufactured layer of a 3-D object has inconsistencies in the object that could affect the performance characteristics of the intended design.

As an object is being made via 3-D printing, improper or inaccurate fabrication of object features can occur. This means that during the layer-by-layer progression of the object, flaws or irregularities that will degrade the intended properties can be formed, then subsequently covered over by the next layer, making the irregularity nearly impossible to find after manufacturing is complete. If undiscovered, a major safety hazard may be created. By nature, the material extrusion and other additive manufacturing processes are extremely dynamic. Tiny system programing alterations can cause major influences on performance, or tiny flow characteristic changes can have complex rheological impacts.

Consequently, an apparatus for obtaining layer data arrays for assessing possible irregularities in the 3-D printed object for structural integrity is disclosed. Furthermore, a method is disclosed for processing the data arrays to detect irregularities and determine the risk level of the object being manufactured (e.g., has object exceeded predetermined risk thresholds).

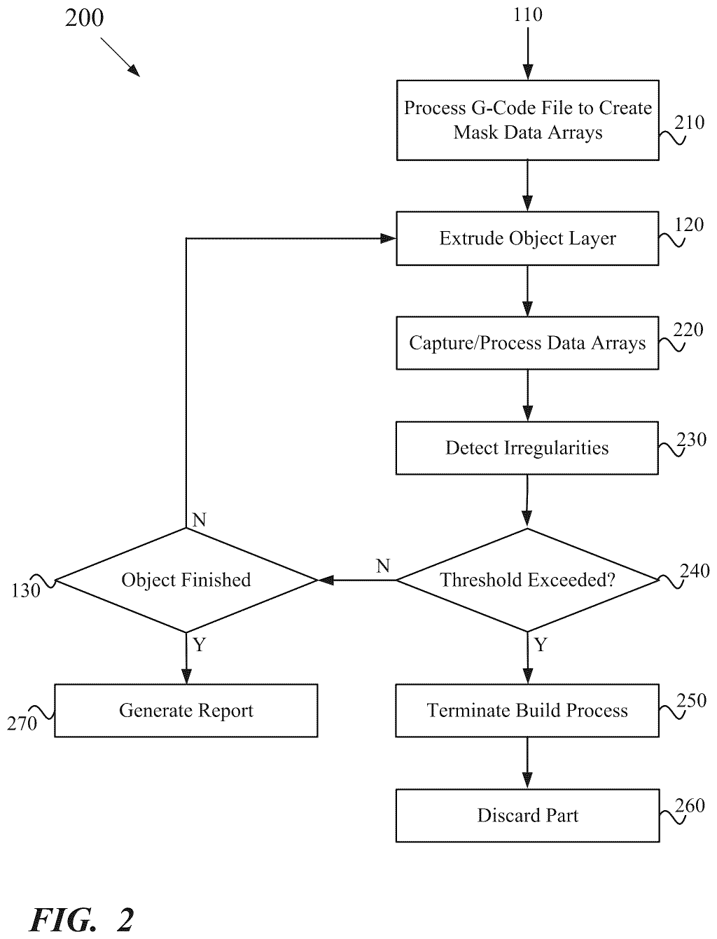

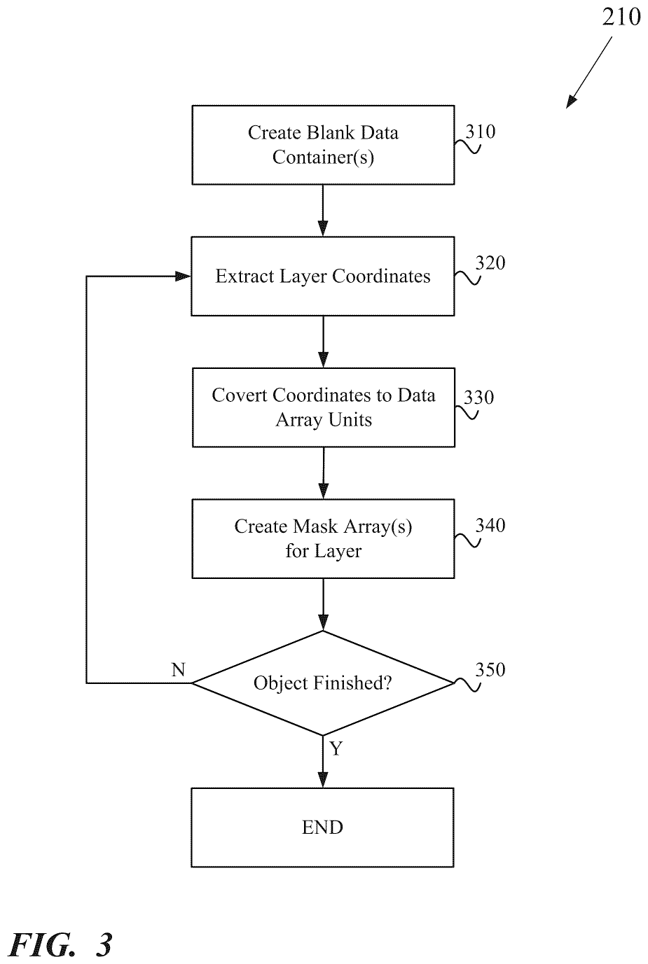

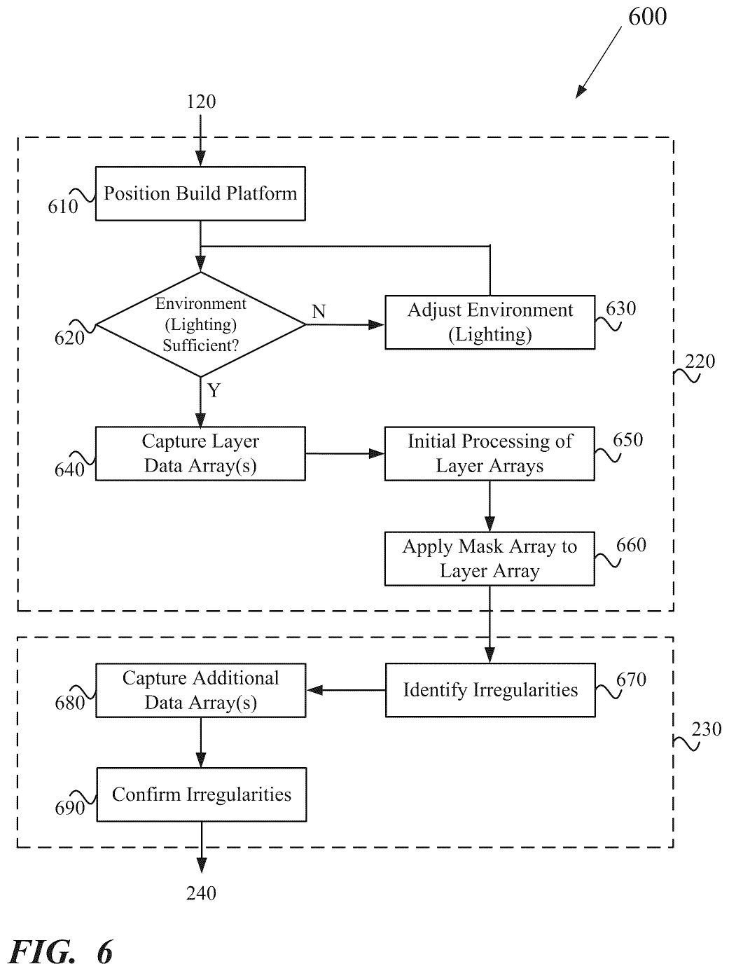

FIG. 2 illustrates an example flow diagram 200 of a material extrusion 3-D printer detecting irregularities or flaws during the manufacture of an object. It should be noted that similar steps to flow diagram 100 are identified with the same reference numbers. The g-code file for the object is processed to create data arrays (e.g., mask arrays) of what each layer of the object should look like when extruded 210. The creation of the mask arrays for each layer will be described in more detail in FIG. 3. After the mask arrays for each layer are created, the 3-D printer begins extruding the desired material along the predetermined path to create a cross sectional area (on appropriate layer) of the object 120. Once a layer has been manufactured, the 3-D printer captures and processes one or more data arrays of the layer 220. The data arrays are utilized for detecting irregularities, such as gaps, voids, or flaws, in the layer 230. The coordinates of the one or more irregularities detected are documented along with the data arrays of the layer. The capturing and processing of the data arrays for each layer 220 and utilizing the data arrays to detect irregularities 230 will be described in more detail in FIG. 6.

Assuming that at least one irregularity is detected, a risk assessment is then performed to determine if the at least one irregularity surpasses one or more predetermined risk thresholds 240. The thresholds may be a number of irregularities, size of grouping of irregularities, frequency of irregularities contained in different layers of the object, percentage of layer or object containing irregularities and/or the like. If no irregularities were detected in the layer, the risk assessment could be skipped. The risk assessment may be performed for the recently manufactured layer, as well as for all manufactured layers to that point. If the one or more irregularities in the recently manufactured layer, or the accumulation of irregularities in the various manufactured layers surpass the one or more risk thresholds (240 Yes), the object fails the risk assessment because the number, size, frequency and/or percentage of the irregularities is too large to produce a safe part at that point in the progression of the manufacturing cycle, even if the remaining progression of the manufacturing cycle proceeded ideally. The manufacturing cycle (build process) is terminated 250 to save material and the object (with however many layers have been printed at that point) is removed and scrapped 260.

If the one or more irregularities in the recently manufactured layer, or the accumulation of irregularities in the various manufactured layers does not reach the one or more risk thresholds (240 No), the object passes the risk assessment. If the object is not complete (130 No), the process continues by extruding a next layer 120. When the object is complete (130 Yes), a report is generated for the object that summarizes any irregularities detected for each layer 270. The report may include data arrays of each layer of the object with irregularities, if any, identified along with relevant data such as the coordinates and size of the irregularities. Operators, technicians, scientists, engineers, or the like, can then use this report to check against, for example, structural Finite Element Analysis (FEA) simulations to confirm that structural irregularities are not present in critical areas, or that the detected irregularities will not degrade quality or performance. The object will either be used or scrapped depending on the analysis of the report.

The flow diagram 200 is not limited to the specific steps and specific order described above. Rather steps may be added, deleted, modified, combined, split apart, or rearranged without departing from the current scope. For example, rather than processing the g-code file 210 for all layers prior to extruding an object layer 120 the g-code file may be processed a layer at a time before the layer is extruded.

FIG. 3 illustrates an example flow diagram of the processing of the g-code file for the object to create mask data arrays for each layer of the object 210. One or more empty data containers are created for each of the corresponding one or more data arrays that are to be captured for the object 310. The empty data containers will have same size, pixel resolution, and color channel (e.g., grayscale; Red, Green, Blue (RGB); or Hue, Saturation, Lightness (HSV)) of the corresponding data arrays captured by the one or more data array capturing sensors. It should be noted that the one or more data array capturing sensors may be a single sensor, multiple sensors of the same type in different positions, different types of sensors in similar positions, different types of sensors in various positions, or some combination thereof.

X-coordinates and y-coordinates are extracted for a layer of the object 320. The physical x-coordinates and y-coordinates of the layer, represented in millimeters, inches, feet, meters, or the like, are converted into data array units (array row index and array column indexes) 330. This is achieved using a conversion factor derived from elements such as data array capturing sensor resolution, working distance, field of view, focal length of the lens, scan width, and the like to accurately represent the physical object in the data array. The one or more empty data containers will then have the extrusion paths written to it for the layer in data array units to create one or more mask data arrays for the layer 340. If the processing of the g-code file for the object is not finished (350 No), then the routine continues and extracts coordinates for a next layer of the object 310. If processing of the object is finished (350 Yes), then the process is complete, and the printer can begin extruding the first object layer.

The flow diagram 210 is not limited to the specific steps and specific order described above. Rather steps may be added, deleted, modified, combined, split apart, or rearranged without departing from the current scope. One or more algorithms may be utilized to perform the processing functions defined above to create mask data arrays for each layer of the object 210. The one or more algorithms can be written in a programming language such as Python, Java, C#, C, C++, R, or the like.

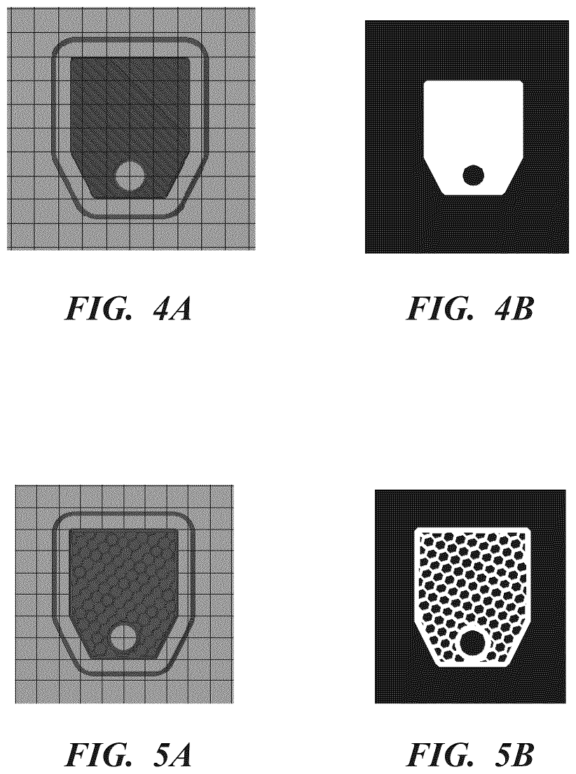

FIGS. 4A-B and 5A-B illustrate data arrays (e.g., images) of example physical details of layers to be extruded and corresponding mask data arrays (images) for the layers to be created therefrom. FIG. 4A illustrates an image of the physical details of a layer shaped as a simple tag that is to be extruded. The ring around the edge of the layer is for case of extruding purposes (nozzle purge) and is not part of the layer. FIG. 4B illustrates a mask layer that is sized for the image to be captured on the actual layer extruded and includes white pixels for location where material should be in the image captured. FIG. 5A illustrates an image of the physical details of a tag shaped layer having a honeycomb structure that is to be extruded. The ring around the edge of the layer is not part of the layer. FIG. 5B illustrates a mask layer that includes white pixels for location where material should be located on the layer including where it is located to form the honeycomb structure. In the examples of FIGS. 4A-B and 5A-B a camera is slated to be the data array capturing sensor and thus was used to create the masks for the layers. However, the invention is in no way intended to be limited to a camera. Rather, other data array capturing sensors including, but not limited to, LiDAR, ultrasonic, eddy current, and laser sensors could have been utilized without departing the current scope.

FIG. 6 illustrates an example flow diagram for utilizing data arrays of the layer extruded to detect irregularities 600. The process 600 includes additional processing steps associated with the capturing and processing one or more data arrays of the layer 220 and the detecting irregularities in the layer 230. After each layer of an object has been extruded 120, the 3-D printer positions the build platform so that the layers of the object can be captured by a data array capturing sensor (e.g., camera) 610. The positioning may include moving the extruder away from the build platform and moving the build platform to be centered with respect to the camera. The positioning may also include a location sensor (e.g., a laser, inductive proximity switch, capacitive proximity switch, Hall effect sensor, or the like) to detect if the build platform is in the correct position. The camera may also be attached to the extruder for higher resolution or larger scale objects. The 3-D printer then utilizes environmental sensors to determine if the environmental (e.g., lighting) conditions are sufficient to obtain a precise, high quality data array(s) 620. For the computer vison algorithms and artificial intelligence algorithms to determine irregularities, data acquisition consistency is critical. If the sensors determine that the environment (lighting) is insufficient (620 No), adjustments are made to the environment (lighting) 630. For example, the lighting may be increased or decreased, the color of the lighting may modified, the temperature of lighting may be modified, or the image zoom level may be adjusted. In this example, parameters that influence the quality of a image captured by the camera are discussed. However the principle could be applied to relevant parameters for other data array capturing sensors, such as temperature and humidity effect on LiDAR sensors.

Once the sensors determine that the environment (lighting) is sufficient (620 Yes), one or more data arrays of the layer are captured 640. Depending on the build envelope of the 3-D printer system, a single data array may be appropriate for adequately capturing the layer or multiple data arrays may be required. The data arrays(s) of the layer are then processed 650. The processing of the data arrays(s) may include automatic contrast and brightness adjustment (e.g., utilizing statistical and histogram-based methods, or the like) for consistency, a matrix operation to remove distortion caused be lens angles, denoising to smooth out unwanted image details (e.g., using local statistical based methods or the like), and/or conversion from data types such as integers to float point decimals, 8 bit integers to 16 bit integers, or the like.

After the data arrays are processed, the mask data array for the layer is used to remove the unwanted areas of the captured data array to create a masked data array that focuses the detection processes on only the area of interest (freshly manufactured layer) 660. The use of the mask array to remove the unwanted areas (e.g., portion of data arrays(s) associated with previous layers) may be performed through bitwise or Boolean data array arithmetic, or the like.

The masked data array(s) are then processed through a series of operations to identify irregularities in the layer 670. The data array processing may include, but is not limited to, color conversion (e.g., color to greyscale, greyscale to color, color to binary, greyscale to binary, or the like), blurring through a statistics based pixel neighbor operation (e.g., simple average blurring, median blurring, Gaussian blurring, or the like), morphological operations (e.g., erosion, dilation, opening, closing, gradient morphology, top hat morphology, white hat morphology, black hat morphology, or the like), and/or thresholding (e.g., binary thresholding, inverted binary thresholding, Otsu's Method for thresholding, adaptive thresholding, local thresholding, global thresholding, or the like).

After the irregularities are identified, an additional one or more data arrays from similar and/or different angles are captured 680. The additional data arrays are utilized to confirm the existence of the irregularities 690. The irregularities may be confirmed using methods such as keypoint detectors, whether it be well known algorithms such as Features from Accelerated Segment Test (FAST), Harris, Good Features To Track (GFTT), Difference of Gaussians (DoG), FAST Hessian, Scale-Invariant Feature Transform (SIFT), RootSIFT, Speeded Up Robust Features (SURF), Binary Robust Independent Elementary Features (BREIF), Oriented FAST and rotated BRIEF (ORB), Binary Robust Invariant Scalable Keypoints (BRISK), binary feature extraction, kernel-based pixel computational methods, Recurring Neural Networks (RNN), Convolutional Neural Networks (CNN), machine language algorithms or the like. If the irregularities are confirmed the process proceeds to the risk assessment 240 of FIG. 2.

If no irregularities were identified, the capturing of different data arrays 680 and the confirmation of the irregularities 690 may be skipped and the process may proceed to determining if the object is complete (130 of FIG. 2). Likewise, if the irregularities were not confirmed the process may proceed to determining if the object is complete (130).

The flow diagram 600 is not limited to the specific steps and specific order described above. Rather steps may be added, deleted, modified, combined, split apart, or rearranged without departing from the current scope. For example, rather than applying a mask array to identify the current manufactured layer in order to remove previously manufactured layers from the data array 660, other methods, potentially more complicated, could be utilized to determine the most recent manufactured layer and remove other portions of the data array.

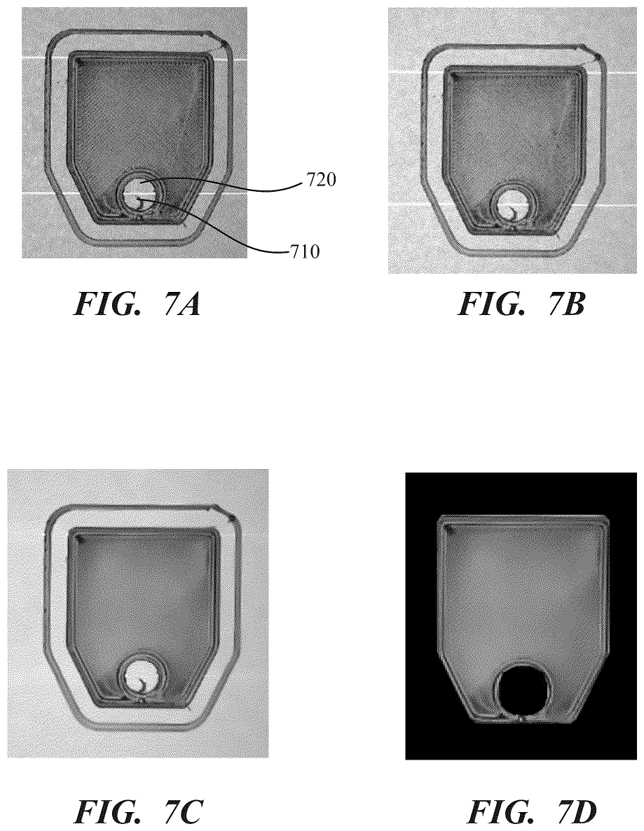

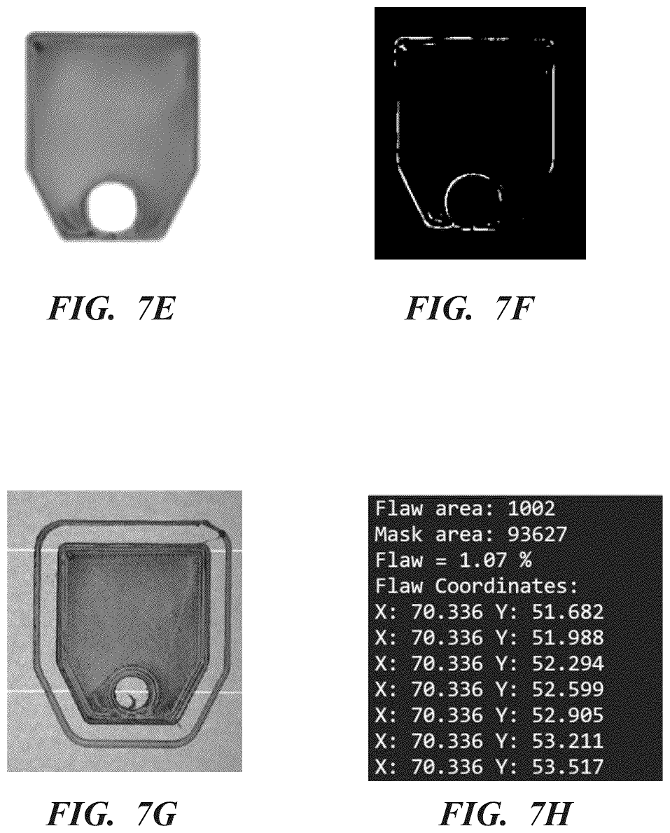

FIGS. 7A-7H illustrate data arrays (e.g., images) of an example layer being captured and processed to identify irregularities. FIG. 7A illustrates an image captured of the layer that was extruded (640). FIG. 7B illustrates the captured image of FIG. 7A after the brightness and contrast have been adjusted (650). FIG. 7C illustrates the brightness/contrast adjusted image of FIG. 7B after it has been denoised (650). FIG. 7D illustrates the denoised image of FIG. 7C after the mask for that layer has been applied to remove anything captured in the image not associated with the layer, including previous extruded layers (660). It should be noted that the shard 710 within the hole 720 visible in FIGS. 7A-7C (but only labeled in FIG. 7A for case of illustration) has been removed since that irregularity was from a previous layer.

FIG. 7E illustrates the masked image of FIG. 7D after it has been blurred and gray scaled (670). FIG. 7F illustrates the blurred/grayscale image of FIG. 7E after black hat morphology and binary thresholding have been performed thereon (670). The white in the image of FIG. 7F are the irregularities (e.g., voids) in the layer. FIG. 7G illustrates the irregularities from FIG. 7F being imposed on the captured image. FIG. 7H illustrates an analysis to identify the percentage of voids in the layer (e.g., 1.07% as illustrated) and the location of the voids in physical dimensions (converted from pixel dimensions). As illustrated, the percentage of voids was simply calculated as the number of pixels identified as voids in FIG. 7F divided by number of pixels in the mask (e.g., FIG. 4B). The analysis is in no way intended to be limited thereby. Rather, the analysis may be performed in various manners without departing from the current scope. The analysis may be used in deciding whether a threshold has been exceeded (e.g., 240).

The example provided in FIGS. 7A-H was based on the use of a camera as the data array capturing sensor. The invention is in no way intended to be limited thereto. As previously discussed, other data array capturing sensors including, but not limited to, LiDAR, ultrasonic, eddy current, or laser sensors could be used without departing from the current scope.

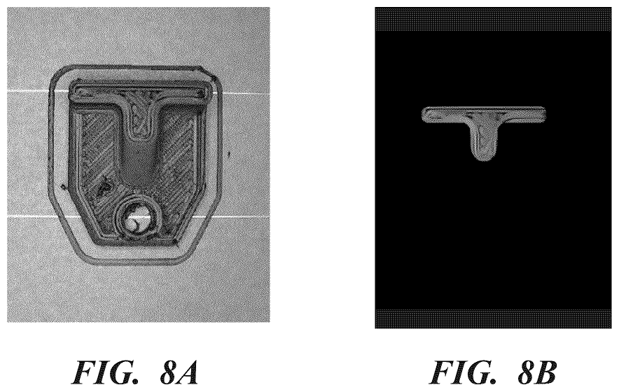

FIGS. 8A-B illustrate an example captured data array (e.g., image) of an object and the captured data array after a mask array for most recent layer has been applied. FIG. 8A illustrates an image captured for an object after a layer has been extruded. As illustrated, the object includes a T-shaped portion that is raised above other portion thereof. As the T-shaped portion is raised it is likely that this is the layer that was extruded and would be the layer that irregularities would be looked for as the other layers would have already been processed. FIG. 8B illustrates the captured image after the mask for the layer is applied so that simply the T-shaped portion is analyzed for irregularities.

The example provided in FIGS. 8A-B was based on the use of a camera as the data array capturing sensor. The invention is in no way intended to be limited thereto. As previously discussed, other data array capturing sensors including, but not limited to, LiDAR, ultrasonic, eddy current, or laser sensors could be used without departing from the current scope.

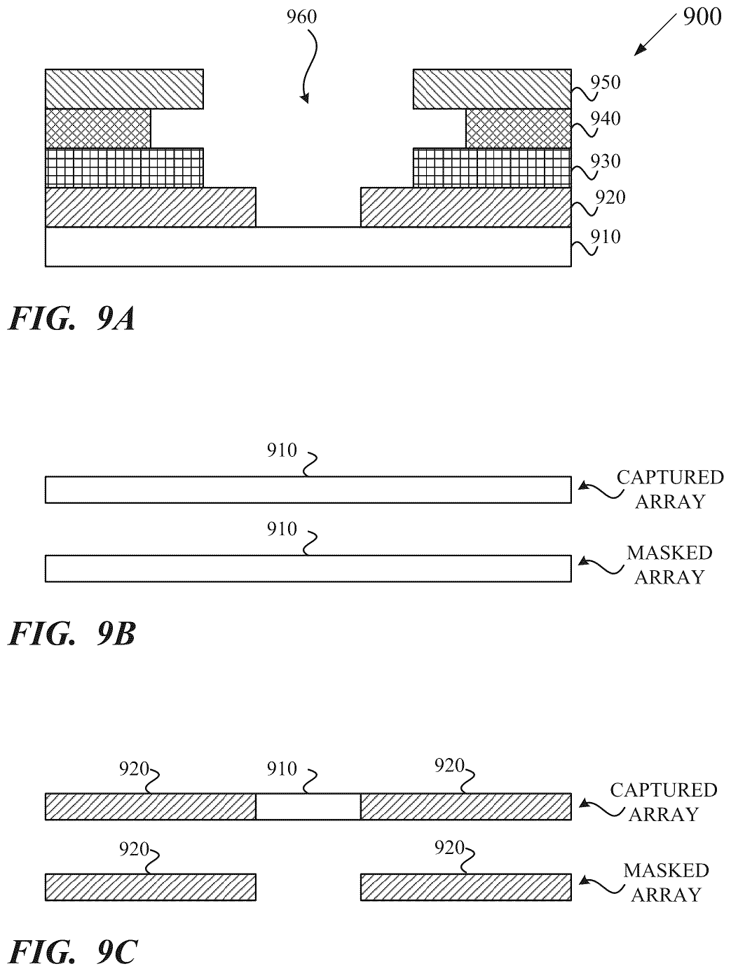

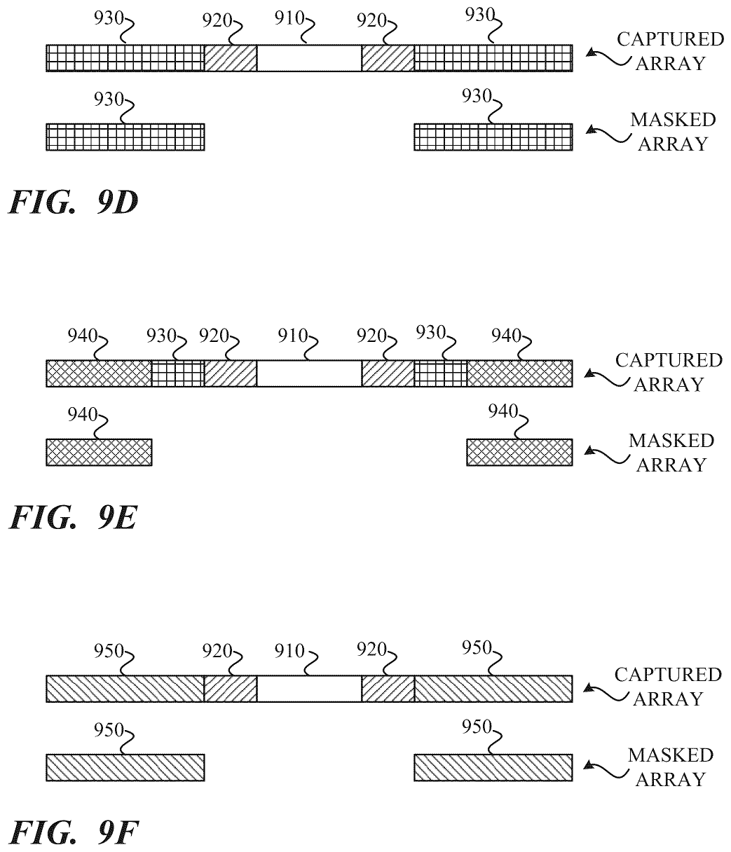

FIGS. 9A-F illustrate the use of mask data arrays created from the g-code file to remove unwanted portions of the data array captured. FIG. 9A illustrates a side view of an object 900 to be created that includes a plurality of layers 910-950 where the layers form a shaped opening 960 within the object 900. FIG. 9B illustrates a data array that would be captured after the first layer 910 was extruded (captured data array) and the data array after a mask array associated with the first layer was utilized (masked data array). As illustrated, the captured data array and the masked data array are identical.

FIG. 9C illustrates the captured and masked data arrays after the second layer 920 was extruded. The captured data array includes the second layer 920 and the first layer 910 that was not covered by the second layer 920. Utilizing the second layer mask array removes the first layer 910 from the masked data array so only the second layer 920 is considered. FIG. 9D illustrates the captured and masked data arrays after the third layer 930 was extruded. The captured data array includes the third layer 930, a portion of the second layer 920 not covered by the third layer 930, and a portion of the first layer 910 not covered by the second or third layers 920, 930. Utilizing the third layer mask array removes the first and second layers 910, 920 from the masked data array so only the third layer 930 is considered.

FIG. 9E illustrates the captured and masked data arrays after the fourth layer 940 was extruded. The captured data array includes the fourth layer 940, a portion of the third layer 930 not covered by the fourth layer 940, a portion of the second layer 920 not covered by the third or fourth layers 920, 930 and a portion of the first layer 910 not covered by the second, third or fourth layers 920, 930, 940. Utilizing the fourth layer mask array removes the first, second and third layers 910, 920, 930 from the masked data array so only the fourth layer 940 is considered. FIG. 9F illustrates the captured and masked data arrays after the fifth layer 950 was extruded. The captured data array includes the fifth layer 950, a portion of the second layer 920 not covered by the fifth layer 950 and a portion of the first layer 910 not covered by the second or fifth layers 920, 950. Utilizing the fifth layer mask array removes the first and second layers 910, 920 from the masked data array so only the fifth layer 950 is considered.

The operation of capturing a data array for a layer and using a mask for the layer to create a masked data array described and illustrated with respect to FIGS. 9A-F may be based on a single array orientation (field of view) or multiple array orientations, and the orientation may be parallel or perpendicular to the build platform (or the object being produced). This will be discussed in more detail with respect to FIGS. 11A-B.

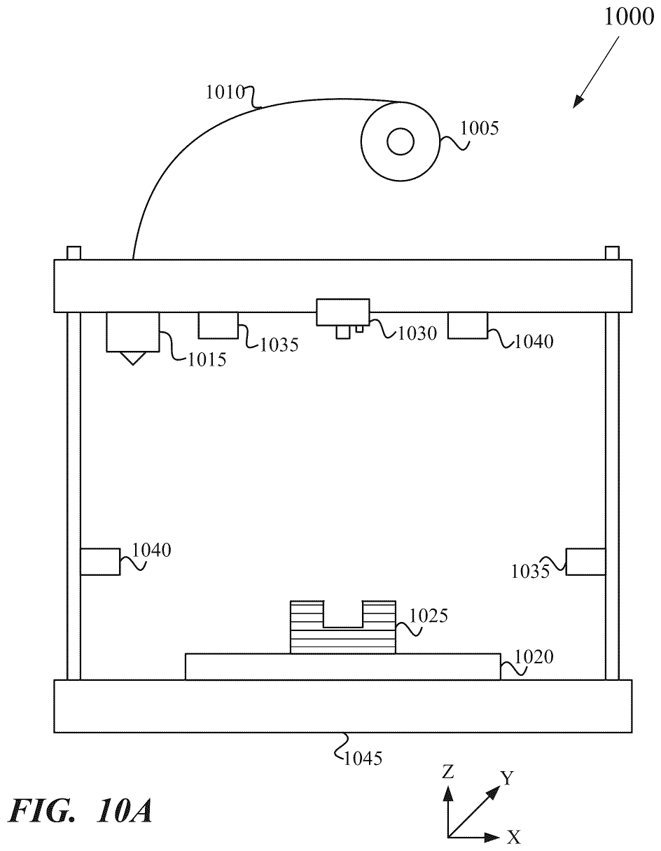

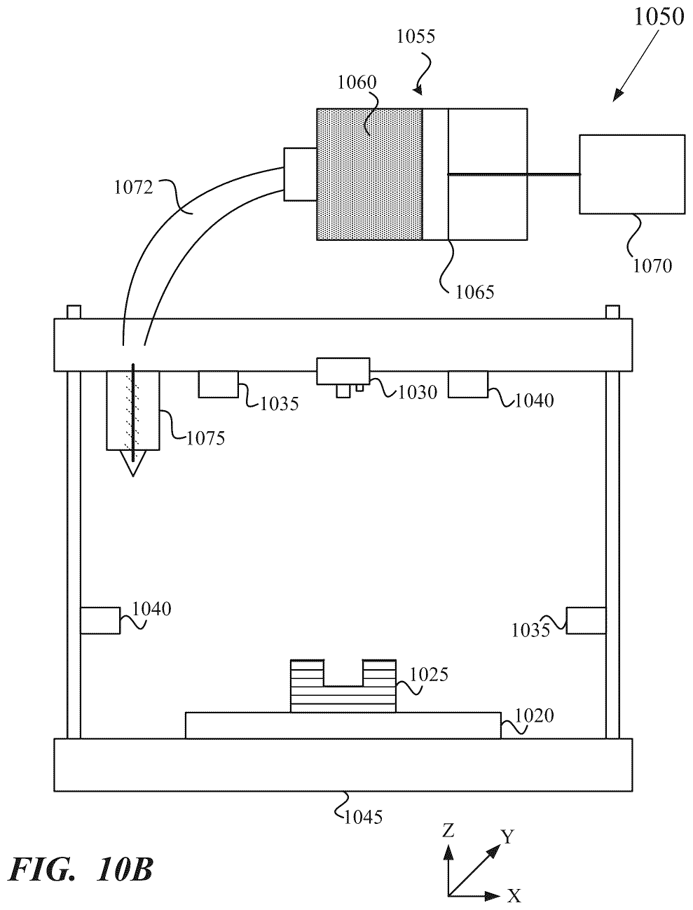

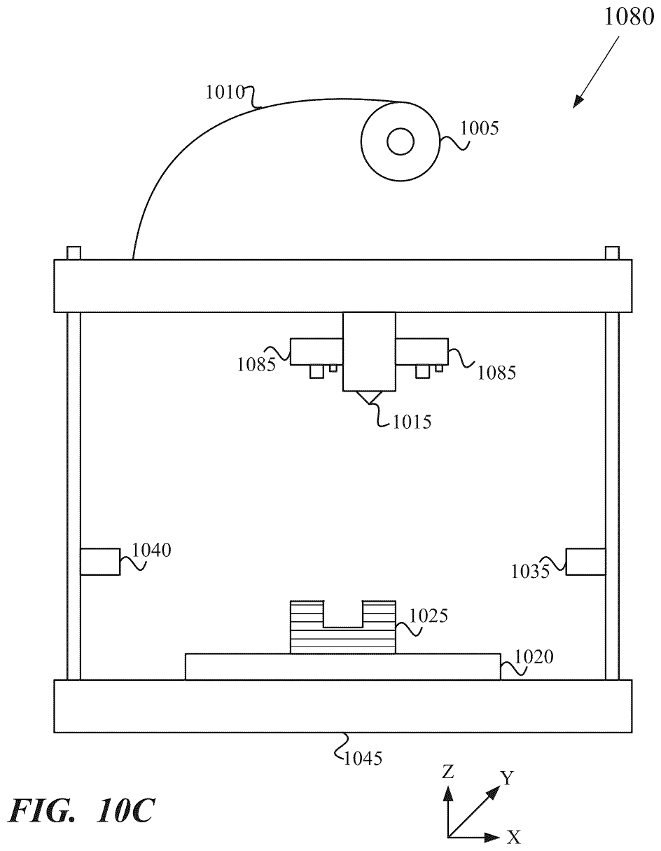

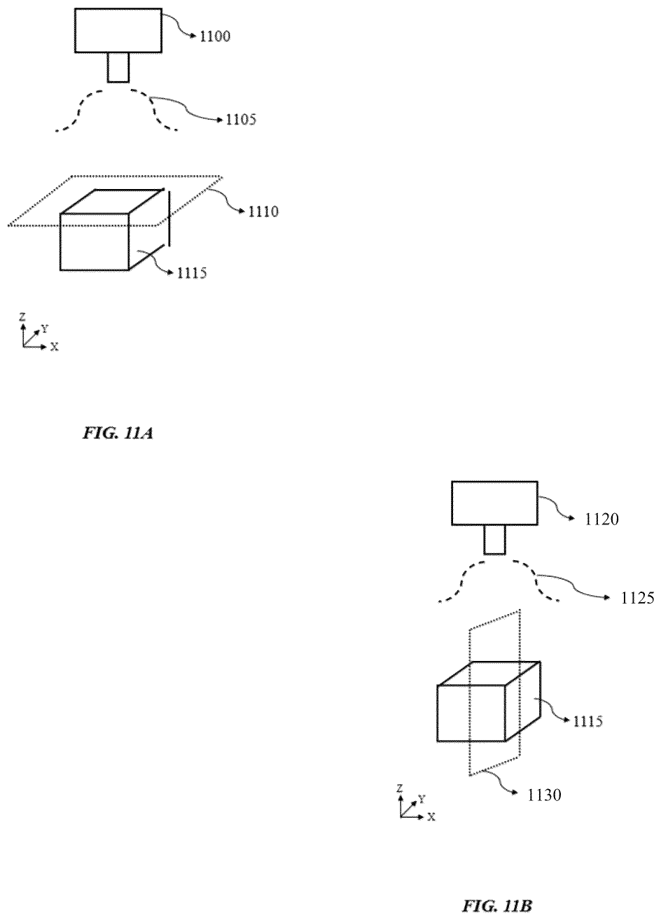

FIG. 10A illustrates a block diagram of an example 3-D printer 1000 to capture data arrays of each layer in order to detect irregularities and determine if a threshold has been exceeded. The 3-D printer 1000 is an FFF printer and includes a spool 1005 of thermoplastic filament 1010 or the like that is supplied to an extruder 1015. The extruder 1015 heats the filament 1010 to a liquid state and extrudes the liquid filament onto a build platform 1020 according to the g-code file to create a 3-D object 1025 layer by layer. After each layer is extruded, data arrays are captured and analyzed to detect irregularities and evaluate the risk of the object being manufactured. In order to capture the data arrays, the extruder 1015 is positioned to be out of the way of a data array capturing device (e.g., camera) 1030 and the build platform 1020 is positioned in the correct position for the data array capturing device 1030 to capture the necessary data arrays.

The 3-D printer 1000 is also equipped with environmental sensing devices (e.g., light sensors) 1035 located throughout the build envelope to determine if data array acquisition conditions need adjustments. The sensors 1035 are illustrated as being located on an upper left side and right wall but are not limited thereby. The 3-D printer 1000 may include additional lights 1040, various color lights, various temperature lights, or the like located throughout the build envelope that can be utilized for optimal data array quality. The additional lights 140 may be controlled by the light sensors 1035 (or other types of environmental sensors). The additional lighting 1040 is illustrated as being located on an upper right side and a left wall but is not intended to be limited thereto. The 3-D printer 1000 further includes a base 1045, with an enclosure to house the controlling electronics or the like.

While not illustrated, the 3-D printer 1000 includes a processor in communication with processor readable storage medium. The processor readable storage medium may be part of the processor, may be separate from the processor, or a combination thereof. Instructions may be stored in the processor readable storage medium that when read and executed by the processor cause the processor to control the operation of the 3-D printer. The processor may further receive instructions from a computer that communicates with the 3-D printer 1000. The processor may execute instructions that are stored in processor readable storage medium on the computer that communicates with the 3-D printer.

The processor may instruct the various parts of the 3-D printer 1000 to manufacture the object based on the g-code file provided thereto. The processor may instruct the various parts of the 3-D printer 1000 to perform the various process flows 200, 210, 600 described above, or modifications of those processes, to detect irregularities in the manufactured object on a layer-by-layer basis and determine if a threshold level is exceeded where the object being manufactured should be discarded.

The 3-D printer 1000 may provide various information captured during the manufacturing of the object, including but not limited to data arrays captured for each layer, the mask array for each layer, and/or information regarding the irregularities detected for each layer, to the computer for the computer to store the information in its memory. The 3-D printer 1000 may include memory to store certain information.

FIG. 10B illustrates an example 3-D printer 1050 that is similar to the printer 1000 but has an alternative material system. Similar items will use the same reference numbers and will not be described to avoid redundancy. The printer 1050 includes a container 1055 that includes a material 1060 that is flowable at room temperature, such as concrete, UV curable resin, energetic material, or the like. The container 1055 includes a piston 1065 that is moved with a motor 1070 or the like to push the material from the container 1055. The material may be provided to an extruder (e.g., screw extruder 1075) via a tube 1072. The screw extruder 1075, or the like, is used to control the material as it is deposited during coordinated moves in the creation of the object 1025.

The print head is illustrated as being an extruder 1075 but is not limited thereto. Rather the print head could be feed wire, blow powders, spread powders, feed materials, extruder materials, or the like without departing from the current scope. The material is not limited to those that can be flowed at room temperature. For example, the material could be made of biological cells, metals, polymers, ceramics, or the like without departing from the current scope.

FIG. 10C illustrates an example 3-D printer 1080. The printer 1080 is similar to the printer 1000 but has an alternative data array capturing sensor. Similar items will use the same reference numbers and will not be described to avoid redundancy. Rather than being mounted in a fixed location, a sensor (e.g., camera) 1085 may be mounted to the extrusion device 1015 and move with it. Such an arrangement enables the data array to be captured as the object 1025 is being printed. According to one embodiment, multiple sensors 1085 may be mounted to the extrusion device 1015. For example, assuming the extruder 1015 moves back and forth along one plane (to left and then to right of page), one second 1085 could be mounted on each side of the extruder 1015 so that one sensor 1085 is ahead of the direction of travel and one is behind the direction of travel regardless of which direction the extruder is moving.

FIGS. 11A-B illustrate example field of view for different data array capturing sensors. FIG. 11A illustrates a sensor 1100 having a sensing field of view 1105 that captures the most recently created layer in the X-Y plane 1110 of the object 1115 being created. A data capturing sensor such as a camera, laser profiler, or the like could capture this field of view 1105. FIG. 11B illustrates a sensor 1120 having a field of view 1125 that is penetrating the surface of the part 1115 to evaluate beneath the surface after the most recently created layer has been manufacture in the Y-Z pane 1130. A data capturing sensor such as an eddy current sensor, x-ray device, or the like could capture this field of view 1125. Regardless of surface or sub-surface evaluation, the capturing, masking, and evaluation procedures are similar.

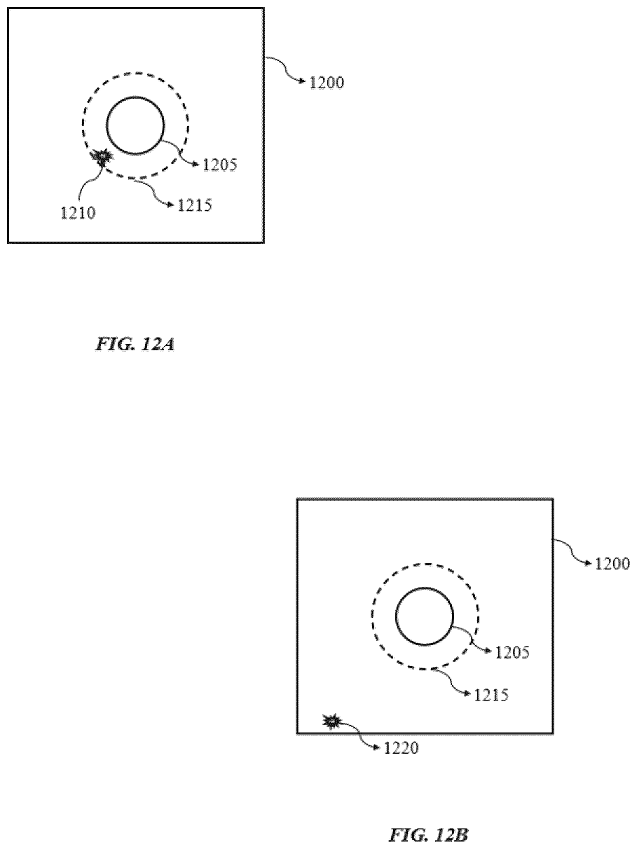

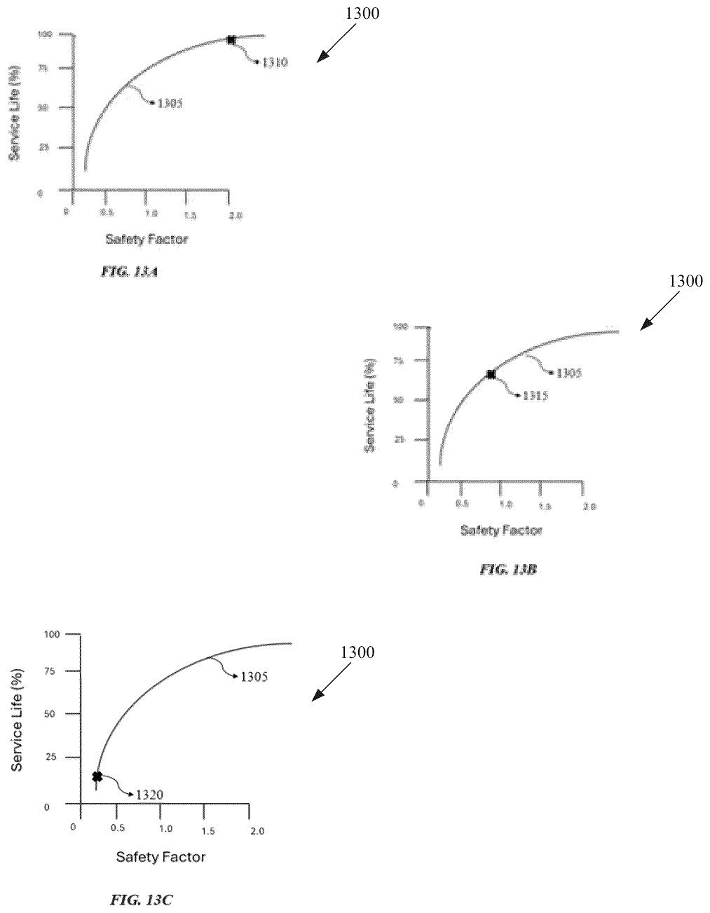

FIGS. 12A-B illustrate a part 1200 with a feature 1205 such as a hole that would be critical to the integrity of the part during its service life. A region directly around the hole 1205 is a critical region 1215 in that less irregularities are tolerated therein. During the additive manufacturing process, an irregularity could occur in any location throughout the volume of the part 1200. FIG. 12A illustrate an irregularity 1210 being located within the critical region 1215. As such, the risk assessment would indicate that the performance of this part in service will be lowered, or in proximity or accumulation of other irregularities, completely compromised.

FIG. 12B illustrates an irregularity 1220 detected outside of the critical region 1215. While the irregularity 1220 is present within the part 1200, it has no effect on the performance of the part 1200 and will not alter the service life of the part 1200. As the irregularity data is collected, this risk assessment can be performed and inform the system on whether the build shall continue on a pass or fail basis, or the like.

FIGS. 13A-C illustrate a plot 1300 of total rated services life (on a scale of 0 to 100 percent) versus safety factor of the design based on its unique loading conditions. As illustrated, a safety factor of 2 is generally used. However, particular applications may have higher or lower safety factors to conserve weight or add redundancy in the design. The curve 1305 depicts a relationship between these factors, where the service life of the part increases as the safety factor increase, until it converges at full-service life. If a part has no irregularities in critical locations that impact the integrity of the part, then it may fulfil the safety factor of 2.0 and provide the full-service life. FIG. 13A illustrates a data point 1310 indicating a part being assigned a full safety factor (e.g., two) and thus having an anticipated full-service life. Such a part would be one that had no irregularities in critical locations (such as the part shown in FIG. 12B) during 3D printing and as a result would pass a risk assessment.

FIG. 13B illustrates a data point 1315 indicating a part being assigned approximately a half safety factor (e.g., one) and thus having half of the anticipated service life. Such a part may have one or more irregularities close to a critical area. The one or more irregularities may not completely render the part useless but may not render the part incapable of sustaining operation over the entire rated service life. For example, the part may be suitable until a replacement can be obtained. The risk assessment for the part would thus lower may lower the design's safety factor (e.g., to approximately one which is half the rated value of two) as indicated by the data point 1315.

FIG. 13C illustrates a data point 1320 indicating a part being assigned a minimal safety factor (e.g., close to zero) and thus having a minimal (if any) service life. Such a part may have one or more irregularities in a critical region (such as the part shown in FIG. 12A) and thus the integrity of the part is compromised. The risk assessment for such a part may indicate immediate part failure.

The disclosure focused on FFF material extrusion to generate structural objects. However, the disclosure is not limited to the extrusion of structural objects. Rather the disclosure could clearly be expanded to cover the extrusion of other objects. For example, material extrusion bio-printing is an up-and-coming field. Using a process similar to the FFF process, biological cell filled mediums are extruded through controlled dispersion out of a syringe to create bio-parts such as skin, car lobes, and other biological features. This is extremely attractive to the medical community due to the difficulty of getting compatible organs from donors and the time it may take to find them. Furthermore, other material extrusion additive manufacturing applications such as 3-D printing energetics on concrete homes, require similar quality control and rigor. The detection of irregularities on a layer-by-layer basis and determination of when a threshold has been exceeded is clearly applicable to this extrusion method as well. The detection and analysis of irregularities may be utilized to detect whether the object is suspectable to infection or has sufficient structural integrity for the intended purpose.

The disclosure focused on FFF or material extrusion based additive manufacturing methods but is intended to be limited thereto. Rather, the disclosure could be implemented in other 3-D printing methods such as material jetting, binder jetting, powder bed fusion, vat polymerization, sheet lamination, or direct energy deposition and the like. Similarly, the material extrusion material is not limited to thermoplastics, and could include materials such as concrete, biological matter, energetics, composites, metals or the like.

Although the disclosure has been illustrated by reference to specific embodiments, it will be apparent that the disclosure is not limited thereto as various changes and modifications may be made thereto without departing from the scope. The various embodiments are intended to be protected broadly within the spirit and scope of the appended claims.

1. A method for detecting irregularities during manufacture of an object using a three-dimensional (3-D) printer, the method comprising
providing toolpath instructions for the object, wherein the toolpath instructions provide physical coordinates for the 3D printer to provide material for each layer of the object;
creating at least one mask for each layer of the object by converting the physical coordinates for the 3D printer to data array units based on at least one corresponding data array to be captured for each layer of the object;
manufacturing a layer of the object;
acquiring at least one data array of the object after the layer is extruded using at least one data array capturing sensor;
utilizing the at least one mask for the corresponding at least one data array for the layer to exclude any part of the at least one acquired data array not associated with the layer to create at least one masked data array for the layer;
processing the at least one masked data array to detect any irregularities in the layer;
determining if the irregularities in the layer or the object exceed one or more defined thresholds; and
continuing the extruding, capturing, acquiring and determining until the manufacture of the object is complete or at least one of the one or more defined thresholds is exceeded.

2. The method of claim 1, wherein the manufacturing includes extruding the layer of the object.

3. The method of claim 1, wherein the at least one data array capturing sensor includes cameras, lasers, LiDAR sensors, ultrasonic sensors, eddy current sensors or a combination thereof.

4. The method of claim 1, further comprising pre-processing the at least one acquired data array prior to the utilizing the at least one mask to ensure consistency between data arrays and remove unwanted details.

5. The method of claim 4, wherein the pre-processing includes at least some subset of contrast and brightness adjustment, a matrix operation to remove distortion caused by lens angles, and denoising to smooth out unwanted data array details.

6. The method of claim 1, wherein the processing includes at least some subset of color conversion, data type conversion, data normalizing, data smoothing, data standardizing, blurring, morphological operations and data array thresholding.

7. The method of claim 1, further comprising configuring the 3-D printer so that the at least one data array capturing sensor can acquire the one or more data arrays.

8. The method of claim 7, wherein the configuring includes at least some subset of
positioning a build platform so that one or more of the layers of the object are available to the at least one data array capturing sensor;
moving a print head so as to not block the at least one data array capturing sensor;
utilizing environmental sensors to determine if conditions are sufficient to capture high-quality data arrays; and
adjusting environmental conditions based on input from the environmental sensors.

9. The method of claim 1, further comprising producing a report documenting irregularities detected in the layers of the object.

10. The method of claim 1, wherein the one or more defined thresholds include at least some subset of number of irregularities, size of grouping of irregularities, frequency of irregularities contained in different layers of the object, percentage of layer containing irregularities and percentage of object containing irregularities.

11. A three-dimensional (3-D) printer for detecting irregularities during manufacture of an object, the 3-D printer comprising
an apparatus for manufacturing the object layer by layer based on toolpath instructions for the object;
a data array capturing sensor to capture a data array of each layer of the object; and
a processor coupled to a non-transitory computer readable storage medium storing instructions that when executed by the processor causes the processor, for each layer, to
create a mask by converting physical coordinates for the 3D printer included in the toolpath instructions to data array units based on parameters of the data array capturing sensor;
utilize the mask to exclude any part of the data array not associated with the layer to create a masked data array;
process the masked data array for the layer to detect if the layer has any irregularities,
document the detected irregularities; and
determine if the detected irregularities for the layer or the object exceed one or more thresholds.

12. The 3-D printer of claim 11, wherein the apparatus includes
a build platform; and
a print head to deposit a material onto the build platform layer by layer.

13. The 3-D printer of claim 12, wherein the material deposited by the print head includes thermoplastic, concrete, biological cells, energetic materials or metal.

14. The 3-D printer of claim 11, wherein the data array capturing sensor is an individual sensor or a plurality of sensors and includes one or more of a camera, a LiDAR sensor, a laser measuring sensor, an ultrasonic sensor, an eddy current sensor or a combination thereof.

15. The 3-D printer of claim 11, wherein when executed the instructions further cause the processor to pre-process the data array prior to utilizing the mask, wherein the pre-processing includes at least some subset contrast and brightness adjustment, a matrix operation to remove distortion caused be lens angles, and denoising to smooth out unwanted data array details.

16. The 3-D printer of claim 11, wherein when executed the instructions cause the processor to process the masked data array by performing at least some subset of color conversion, data array blurring, morphological operations and data array thresholding.

17. The 3-D printer of claim 11, further comprising environmental sensors to determine if conditions are sufficient to capture precise high-quality data arrays.

18. The 3-D printer of claim 11, further comprising lighting to adjust lighting on the object in order to capture precise high-quality data arrays.

19. The 3-D printer of claim 11, wherein when executed the instructions further cause the processor to produce a report documenting irregularities detected in the layers of the object.

20. The 3-D printer of claim 11, wherein the one or more thresholds include at least some subset of number of irregularities, size of grouping of irregularities, frequency of irregularities contained in different layers of the object, percentage of layer containing irregularities and percentage of object containing irregularities.
